(19) United States
(12) Patent Application Publication
(10) Pub. No.: US 2025/0232180 A1
(43) Pub. Date: Jul. 17, 2025

(54) PROVIDING A SUITABILITY PROMPT TO EVALUATE AND IMPROVE THE OUTPUT OF A GENERATIVE MODEL WITHOUT FINE TUNING

(71) Applicant: Apple Inc., Cupertino, CA (US)

(72) Inventors: Griffin Dietz Smith, Seattle, WA (US); Leah Findlater, Seattle, WA (US); Ryan B. Shapiro, Seattle, WA (US); Matthew J. Davidson, Austin, TX (US); Siddhartha A. Prasad, Boston, MA (US)

(21) Appl. No.: 18/638,021

(22) Filed: Apr. 17, 2024

Related U.S. Application Data
(60) Provisional application No. 63/621,228, filed on Jan. 16, 2024.

(51) Int. Cl. G06N 3/091; G06N 3/0475

(52) U.S. Cl. CPC G06N 3/091; G06N 3/0475

(57) ABSTRACT

The present technology provides a mechanism to obtain results of similar quality to that which can be obtained by fine-tuning a generative model from the foundational model without fine-tuning. In particular, the present technology can provide a suitability prompt to evaluate and improve the output of a generative model without fine-tuning. A suitability prompt is an engineered prompt that is provided to a generative model that prompts the generative model to evaluate a candidate response that has been generated by the generative model. Often the suitability prompt can include an indication of one or more attributes of a quality candidate response. When the generative model provides a response to the suitability prompt that indicates that the candidate response is a quality response, the candidate response can be deemed good enough to be returned to a user.

### BACKGROUND

Machine learning models, and in particular generative models, can require fine-tuning before the machine learning models are suitable for use with specific tasks in a commercial setting. However, such fine-tuning typically requires computational resources and high-quality data providing good examples of the results that are to be trained on.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example book application for use in accordance with some aspects of the present technology.

FIG. 2 illustrates an example system arrangement of question-generating application in accordance with some aspects of the present technology.

FIG. 3 illustrates an example process for interacting with a generative model to get responses with improved quality without fine-tuning the large language model for the use case in accordance with some aspects of the present technology.

FIG. 4 illustrates a table outlining types or categories of questions that can facilitate dialogic reading in accordance with some aspects of the present technology.

FIG. 5 illustrates a table of example questions and determinations of why the example questions might be found to be suitable and the reasoning for that conclusion in accordance with some aspects of the present technology.

FIG. 6A illustrates an example of the book application at the time t=0 in accordance with some aspects of the present technology.

FIG. 6B illustrates a sample of the book application at time t=1, which occurs after a suitable response has been provided by the generative model in accordance with some aspects of the present technology.

FIG. 7 shows an example of a system for implementing some aspect of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Machine learning models, and in particular generative models, can require fine-tuning before the machine learning models are suitable for use with specific tasks in a commercial setting. However, such fine-tuning typically requires computational resources and high-quality data providing good examples of the results that are to be trained on. Often, fine-tuning also requires experts to create or curate suitable data for fine-tuning and to evaluate the performance of the model to provide reinforcement or correction to the model (e.g., reinforcement learning). Unfortunately, such resources are not available to many, which somewhat limits what might be accomplished by individuals and small groups.

The present technology provides a mechanism to obtain results of similar quality to that which can be obtained by fine-tuning a generative model from the foundational model without fine-tuning. In particular, the present technology can provide a suitability prompt to evaluate and improve the output of a generative model without fine-tuning. A suitability prompt is an engineered prompt that is provided to a generative model that prompts the generative model to evaluate a candidate response that has been generated by the generative model. Often the suitability prompt can include an indication of one or more attributes of a quality candidate response. When the generative model provides a response to the suitability prompt that indicates that the candidate response is a quality response, the candidate response can be deemed good enough to be returned to a user. Or, when the generative model provides a response to the suitability prompt that indicates that the candidate response is not a quality response, a revision prompt can be provided to cause the generative model to try again to produce a higher quality response.

Throughout this description, the present technology will be described in the context of an example of a question-generating application that can generate questions that promote dialogic reading based on a book being read by beginning-level readers. In dialogic reading, adults lead a contextually meaningful dialogue with children by asking specific types of story-related questions that target vocabulary development, phenomic awareness, recall, expressive fluency, and building connections between stories and a child's life. While the question-generating application uses carefully engineered prompts designed to instruct a generative model to produce a question that achieves goals such as those listed, there can be considerable variability in the output from the generative model as not all questions that appear to achieve these goals are considered high-quality responses such that they will generate a meaningful dialogue.

As noted above, a common practice in the art would be to fine-tune the generative model to distinguish high-quality responses from lower-quality responses. However, this may not be practical because the identification of high-quality responses would require expert educators to invest a significant amount of time ranking responses output by the generative model, and then would require significant time and computational resources to fine-tune the model to reach an acceptable level performance. For this use case, these demands were not deemed practical.

Instead, the question-generating application can create follow-up prompts, called suitability prompts, which ask the generative model to evaluate a candidate response already generated by the generative model to provide an answer as to whether the candidate response meets one or more quality criteria. These quality criteria can be based on a quality rubric that is used to evaluate candidate responses.

Using this method, the present technology can avoid fine-tuning a generative model by instead asking the generative model to evaluate the quality of its output. Throughout this description examples are provided whereby multiple prompts are provided in order to generate a candidate response and then to evaluate the candidate response, however, it is also possible for the initial prompt to both provide a request to the generative model to generate a question that both achieves the stated goals and that meets the quality criteria. While this is possible, and it is explicitly contemplated as falling within the scope of the present technology, the method of interacting with the generative model through multiple prompts is used in most examples for two reasons. The first reason is that this method of explanation makes clearer the purpose of each one of the prompts. The second reason is that it has been shown that some generative models struggle to direct their attention to all the critical aspects of lengthy prompts. Thus, while the present technology is primarily directed to the concept that a generative model can be prompted to perform a specific task with quality typically only seen through fine-tuning when the generative model is given information about quality criteria that may be used to evaluate the quality of a response, the present technology secondarily contemplates a method of interacting with the generative model in a way that forces the generative model to be attentive to the question generating criteria and to the quality criteria.

The present technology provides a significant advantage in that it is not necessary to fine-tune a foundational model for use with even specific tasks. This substantially reduces human and computational burdens for developing quality training data and reduces computational time from the training process. Interestingly, in some instances, some of these benefits may actually erode over time. More specifically, while there are clear savings in the use of computational resources by avoiding training of the machine learning model, there may be an incrementally greater burden on the use of the generative model that is a result of providing additional prompts or longer and more complex prompts, to the generative model. Depending on the size of the generative model (how many parameters) and the deployment of the generative model (is the generative model running on expensive cloud resources or less expensive personal computing device resources), the net savings on computation resources from avoiding fine-tuning may vary.

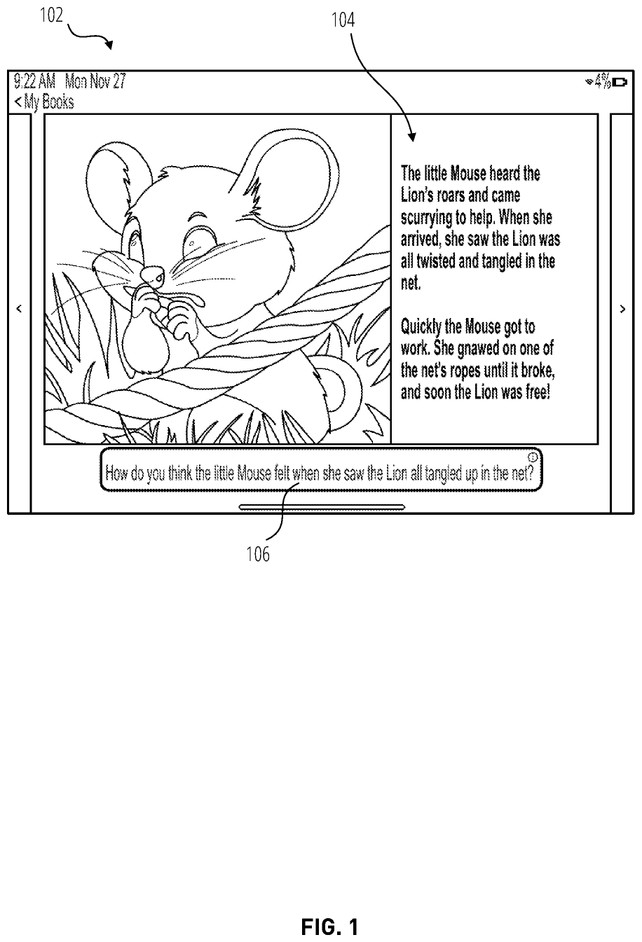

FIG. 1 illustrates an example book application for use in accordance with some aspects of the present technology. As illustrated in FIG. 1, book application 102 displays story content 104 which, in this case, includes text and an image. By interacting with the present technology, the book application 102 can receive a high-quality question from a generative model to promote dialogic reading 106 and present the question in the book application 102.

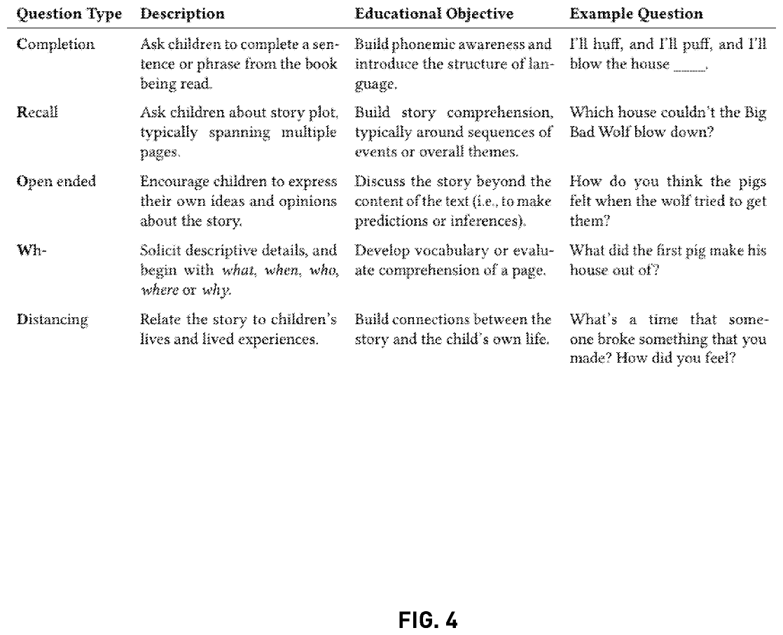

The question-generating application can be provided with templates to create a generation prompt to be provided to a generative model to generate a question. In some embodiments, the generation prompt can correspond to a type of question (see FIG. 4 for more information on question types) that can facilitate dialogic reading. When the generative model provides a candidate response, the question-generating application can provide one or more suitability prompts that are created from a quality response rubric. For example, suitability prompts can prompt the generative model to evaluate the candidate response for wording, authenticity, complexity, etc. In some instances, the suitability prompts are varied based on the type of question requested in the generation prompt.

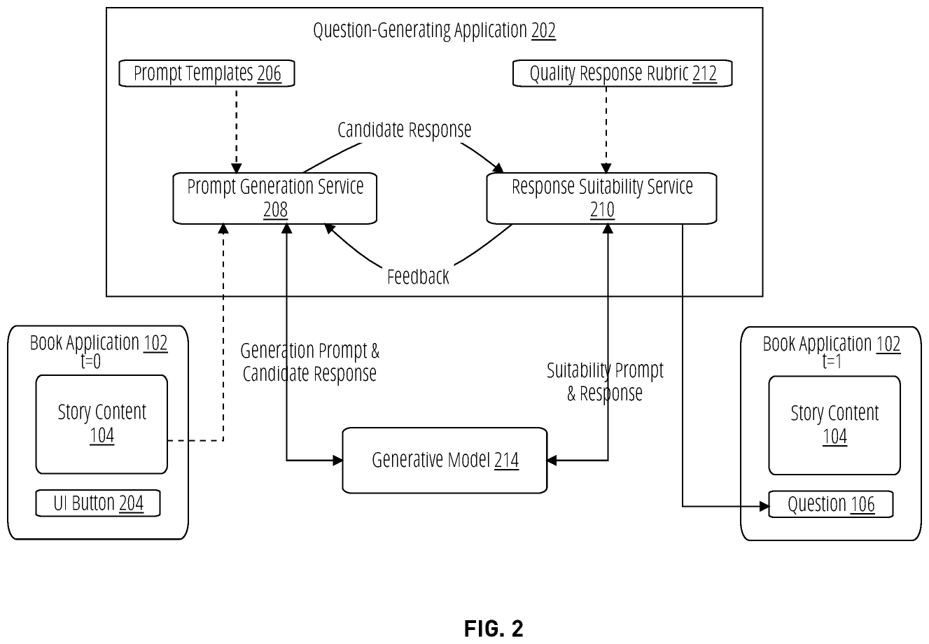

FIG. 2 illustrates an example system arrangement of question-generating application in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

FIG. 2 illustrates an example system arrangement of question-generating application 202 in accordance with some aspects of the present technology. While question-generating application 202 is named in the context of a particular use case, the present technology pertains to any application that can provide suitability prompts to a generative model for the purpose of evaluating the suitability of the output of the generative model for a particular purpose. While throughout the present description, the technology is described in the context of a question-generating application 202 that is utilized to provide questions that promote dialogic reading, this is just an example use case only. The output of the present technology is not limited to outputting questions.

As illustrated in FIG. 2, book application 102 is illustrated at a time t=0 and then later at a time t=1. At time t=0 the book application 102 can be configured to request questions appropriate for facilitating dialogic reading of story content 104. Book application 102 can automatically request and then present a question to promote dialogic reading 106, or a user can interact with UI button 204 to cause the book application 102 to request and then present the question to promote dialogic reading 106.

The question-generating application 202 includes a prompt generation service 208 that is configured to combine a selected prompt template 206 with story content 104 extracted from a book displayed in book application 102. As described herein, the question-generating application 202 can send the prompt created by prompt generation service 208 to a generative model 214 in order to receive a candidate response, e.g., a candidate question that can promote dialogic reading in the context of the story content 104. In some embodiments, the prompt template can change by question type. In some embodiments, the question type is randomly selected. In some embodiments, the question type is selected using logic based on factors such as parent preference, child age, context of the story, etc.

While FIG. 2 illustrates the generative model 214 as being separate from the question-generating application 202, this is by way of illustration only, and the generative model can be part of question-generating application 202. Likewise, the question-generating application 202 could be part of book application 102 even though they are shown as separate entities.

The prompt generation service 208 is further configured to receive a candidate response from generative model 214 and passes the candidate response to response suitability service 210. The response suitability service 210 is configured to prompt the generative model 214 to evaluate the suitability of the candidate response based on suitability criteria provided by the quality response rubric 212. Depending on the response provided by the generative model 214, the response suitability service 210 can deem the candidate response suitable or can provide feedback to the prompt generation service 208 to have further interactions with the generative model 214 to receive a revised candidate response.

A response that has been deemed suitable can be returned to book application 102 at time t=1 to be displayed as a question to promote dialogic reading 106 along with the story content 104.

In some embodiments, generative model 214 can be any service capable of generating suitable output content in response to receiving a prompt. For example, generative model 204 can be a machine-learning model or other technology with natural language processing capabilities and/or image-generating capabilities. The present technology is agnostic to the particular generative model 214 utilized, and different generative models 214 can be utilized merely by calling an application programming interface of a different generative model 214.

In some examples, the generative model 214 can be a large language model such as OPEN AI'S CHATGPT, or GOOGLE's BARD, or ANTHROPIC's CLAUDE.

Large Language Models (LLMs), exemplified by GPT (Generative Pre-trained Transformer) and BERT (Bidirectional Encoder Representations from Transformers), are founded on deep neural network architectures and have been trained on immense datasets comprised of internet text. The training process involves immersing the model in vast amounts of text, allowing it to internalize the intricacies of language, encompassing grammar, syntax, semantics, and the subtleties of contextual understanding. LLMs generate content probabilistically, as LLMs sample from probability distributions to determine the most likely next word or sequence of words based on their training.

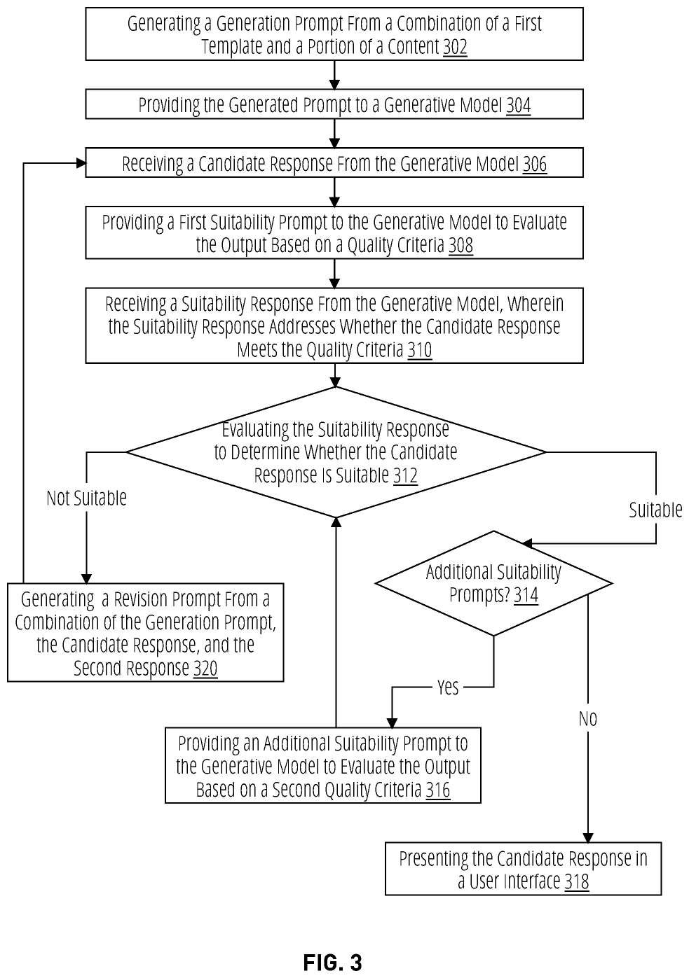

FIG. 3 illustrates an example process for interacting with a generative model to get responses with improved quality without fine-tuning the generative model for the use case in accordance with some aspects of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

FIG. 3 will be addressed in the context of FIG. 2.

In the context of the example use case in which the present technology is being described, a book application 102 can be configured to request questions appropriate for facilitating dialogic reading of story content 104. Book application 102 can automatically request and then present a question to promote dialogic reading 106, or a user can interact with UI button 204 to cause the book application 102 to request and then present the question to promote dialogic reading 106.

According to some examples, irrespective of whether the user initiates the request for a question, the method includes generating a generation prompt from a combination of a first template and a portion of the content at block 302. For example, the prompt generation service 208 illustrated in FIG. 2 may generate a generation prompt from a combination of a first template from prompt templates 206 and a portion of story content 104.

In some embodiments, the book application 102 is executed on a personal computing device such as a laptop, smartphone, tablet, e-reader, or spatial computing device. The question-generating application 202 can be operating on the same device as the book application 102, or can be executed in a computing cloud. In some embodiments, the question-generating application 202 can be part of the book application 102. In some embodiments, the book application 102 and the question-generating application 202 are logically separate applications (for example, the question-generating application 202 may be operating as a service type application), and the book application 102 can interact with the question-generating application 202 via an application programming interface.

The first template is one of several templates where the templates are engineered to cause a generative model to output a type of question that will facilitate a discussion of the content. For example, FIG. 4 illustrates a table outlining types or categories of questions that can facilitate dialogic reading in accordance with some aspects of the present technology. FIG. 4 also includes a description of these types of questions, the objective of these types of questions, and an example of the types of questions. Based on information such as displayed in the table in FIG. 4 engineered prompt templates 206 can be created.

In particular, FIG. 4 outlines questions broken into five categories that map to the acronym CROWD. CROWD identifies 5 types of prompts that could initiate dialogue-Completion, Recall, Open ended, Wh-, and Distancing. Each prompt type has a specific educational objective. The last column includes examples of each prompt type for the story, “The Three Little Pigs.”

The prompt templates 206 include a reference to the story content 104 such that a prompt template can be combined with portions of the story content 104 to result in the generation prompt. In some examples, the story content 104 can include information from a range of pages, or might include information from a specific paragraph. In some examples, the story content 104 can include text from the story, images from the story, or a combination of text and images.

An example prompt can be:
“Act as an early childhood reading instructor, producing ‘dialogic reading’ prompts that encourage conversation and engagement with the text. Generate an {prompt type} prompt, that {prompt goals}. Remember that the language you use to create [PROMPT] and the themes you pull from the text must be age appropriate for 4-6 year olds. Make sure [PROMPT] is to the point, and is not verbose. Read the following text and use it to better understand the characters and events of the main text block. DO NOT use any of the text for prompting. Format responses in JSON using exactly the template below:
{
“prompt”: PROMPT
}
With that context, generate a prompt of type {prompt type} for this main text: {current page text}”

So as an example, we may have:
{prompt type}=open-ended
{prompt goals}=encourages the child to express their own ideas and opinions about the story. This prompt should allow for creativity and imagination. Avoid questions that can be answered with a simple yes or no.
{previous page text}=the text from the prior page
{current page text}=the text from the current page of the story

In some examples the prompt could be amended with “Here are some examples of UNSUITABLE prompts for [CURRENT_PAGE] and [PREVIOUS_PAGES]:” and a list of questions that failed the quality response rubric and why.

Accordingly, the generation of the generation prompt by the prompt generation service 208 can include selecting a prompt from the prompt templates 206 and combining the selected prompt template with relevant story content 104.

According to some examples, the method includes providing the generated prompt to a generative model at block 304. For example, the prompt generation service 208 illustrated in FIG. 2 may provide the generated prompt to a generative model. In some embodiments, the generative model is a large language model.

The generative model 214 can be operated on the same device as the book application 102 (a personal computing device) or be operated in a cloud environment. The generative model 214 is a foundation model or other model that is not fine-tuned for the purpose of generating questions to promote dialogic reading 106. The prompt generation service 208 and the response suitability service 210 can interact with the generative model 214 via one or more application programming interfaces.

According to some examples, the method includes receiving a candidate response from the generative model at block 306. For example, the question-generating application 202 illustrated in FIG. 2 may receive a candidate response from the generative model. The candidate response was created by the generative model in response to the generated prompt. As introduced above, this candidate response may not be of sufficient quality given that the generative model 214 was not fine-tuned. To check that the candidate response is of sufficient quality, the present technology can utilize the capabilities of the generative model 214 to evaluate the quality of the candidate response against specific criteria.

According to some examples, the method includes providing a first suitability prompt to the generative model to evaluate the output based on quality criteria at block 308. For example, the response suitability service 210 illustrated in FIG. 2 may provide a first suitability prompt to the generative model to evaluate the output based on quality criteria. The suitability prompt is created by selecting an appropriate suitability prompt template from the quality response rubric 212 and combining it with the candidate response. The first suitability prompt can be one of a plurality of suitability prompts provided to the generative model to evaluate the characteristics of the candidate response. The plurality of suitability prompts corresponds to factors in a quality response rubric.

The quality response rubric addresses factors used to evaluate whether a question based on the story will facilitate the discussion of the content. The quality response rubric 212 includes suitability prompt templates for each generation prompt type (e.g., CROWD prompt type for the question to promote dialogic reading example). There can be multiple suitability prompts for each generation prompt type, where the multiple suitability prompts can be configured to be presented to the generative model one at a time. For example, for a generation prompt type, there can be three suitability prompts-one for the wording of the candidate response, one for the authenticity of the candidate response, and one for the complexity of the candidate response. These suitability prompts can be delivered one at a time, or in parallel, or all as part of the same suitability prompt.

The quality response rubric 212 can be created by one or more experts. In this way, the input of experts can be more efficiently obtained and applied then having experts label thousands of samples for use in fine-tuning the generative model. The quality criteria in the quality response rubric includes expert knowledge. Not only is this method more efficient, but the knowledge of experts is explicitly applied to all outputs of the generative model, whereas, with fine-tuning, it may be hard to verify that the expert's knowledge is being leveraged for any particular candidate response.

According to some examples, the method includes receiving a suitability response from the generative model, wherein the suitability response addresses whether the candidate response meets the quality criteria at block 310. For example, the response suitability service 210 illustrated in FIG. 2 may receive a suitability response from the generative model, wherein the suitability response addresses whether the candidate response meets the quality criteria.

According to some examples, the method includes evaluating the suitability response to determine whether the candidate response is suitable at decision block 312. For example, the response suitability service 210 illustrated in FIG. 2 may evaluate the suitability response to determine whether the candidate response is suitable.

For example, the suitability prompts are engineered to cause a suitability response to be generated that provides a clear understanding of whether the candidate response meets the specific suitability criteria and, if not, a reason why. In some embodiments, this can involve multiple prompts and responses wherein a first response might indicate that the response is not suitable, and a follow up prompt and response can address the reason why the candidate response was not deemed suitable.

When it is determined that the candidate response is deemed suitable in the context of the suitability criteria articulated in the suitability prompt, the method can proceed to determine whether any other suitability prompts remain to be presented at decision block 314. If there are other suitability prompts to be presented, the method includes providing an additional suitability prompt to the generative model to evaluate the output based on additional quality criteria at block 316.

When it is determined that there are no other suitability prompts remaining to be presented at decision block 314, the method includes presenting the candidate response in a user interface at block 318. For example, the question-generating application 202 can provide the suitable candidate response to the book application 102 for presentation as the question to promote dialogic reading 106.

If, however, the candidate response was deemed not suitable in light of any of the criteria articulated in one of the suitability prompts at decision block 312, the method includes generating a revision prompt from a combination of the generation prompt, the candidate response, and the suitability response at block 320. It is determined that the candidate response is not suitable when the suitability response includes a reason why the candidate response is not suitable in light of the quality criteria included in the suitability prompt. For example, the response suitability service 210 illustrated in FIG. 2 may generate a revision prompt from a combination of the generation prompt, the candidate response, and the second response. The revision prompt requests a revised response that addresses the reason why the candidate response is not suitable in light of the quality criteria for which the candidate response was deemed not to satisfy.

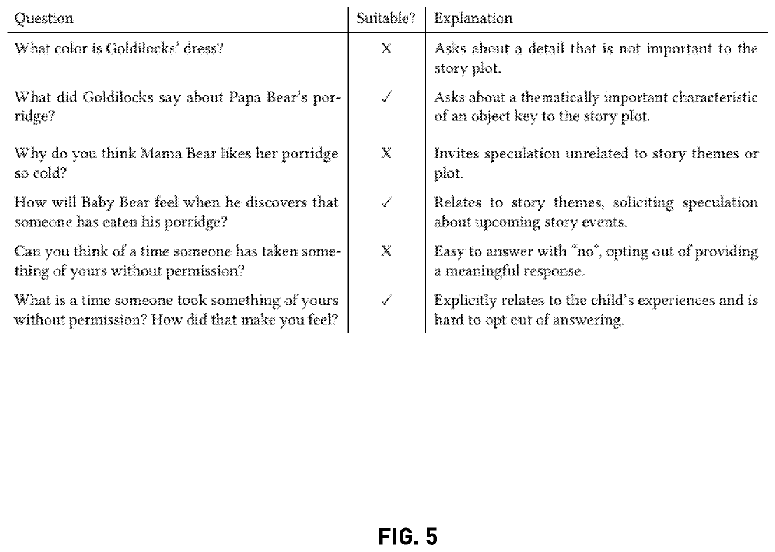

FIG. 5 illustrates a table of example questions and determinations of why the example questions might be found to be suitable and the reasoning for that conclusion in accordance with some aspects of the present technology. The questions in the table in FIG. 5 are based on the well-known story of “Goldilocks And The Three Bears.” In the table, some example questions have been indicated as suitable or not. The questions that have been deemed not suitable are for reasons such as the question pertains to details that are not important to the plot, the question invites speculation about something unrelated to the story themes, or the question can be evaded with a simple answer.

As has been asserted herein, the present technology can provide similar quality responses at a frequency much greater than a foundation model that has not yet been fine-tuned, and in some respects, the present technology can approach similar quality as if the generative model had been fine-tuned for the specific task. This assertion was able to be validated by evaluating the quality of questions produced by the present technology and evaluating the quality of questions generated by the generative model using the same prompts but without the suitability response evaluation. The questions generated by both methods were presented to four primary-school educators, who were asked to rate each question's likelihood to foster contextually meaningful dialogue between a parent and a child on a scale from 1 (very unlikely) to 5 (very likely). Reasoning that a question's score depends on both the generation system and the biases of the rater, an ordinal logistic regression was ran with ratings assigned by these educators as a dependent variable and system and rater as the independent variables. Controlling for rater, it was found that questions generated by the present technology (including the suitability response evaluation) were 1.64 times more likely to have a higher rating than those generated by the generative model lacking the suitability response evaluation. Of the 165 questions produced by the present technology (including the suitability response evaluation), educators gave 135 of them a score of 3 or higher, representing an overall suitable question rate of 79%. By contrast, the generative model lacking the suitability response evaluation had a suitability rate of 69%.

While the above method was presented in the context of generating questions to promote dialogic reading, the present technology is not limited to such a use case. The present technology can be adapted to any use case where sufficient quality response criteria for the use case can be reflected in suitability prompts. The higher the quality of the prompts and the criteria they contain, the better the output of the present technology should be.

One example of an additional use case might be the use of the present technology to generate high-quality descriptions of apps or other content in an online store. In such an example, an application can provide a generation prompt to cause the generative model to output a description of the content. Then the response suitability service can interact with the generative model to determine if the description of the content is sufficiently high quality. For example, some factors might be that the description uses a tone appropriate for marketing language, that the description is not critical of the product, and that the description is clear-among other possible factors. Suitable descriptions can be published, while other descriptions can be revised to overcome their deficiency.

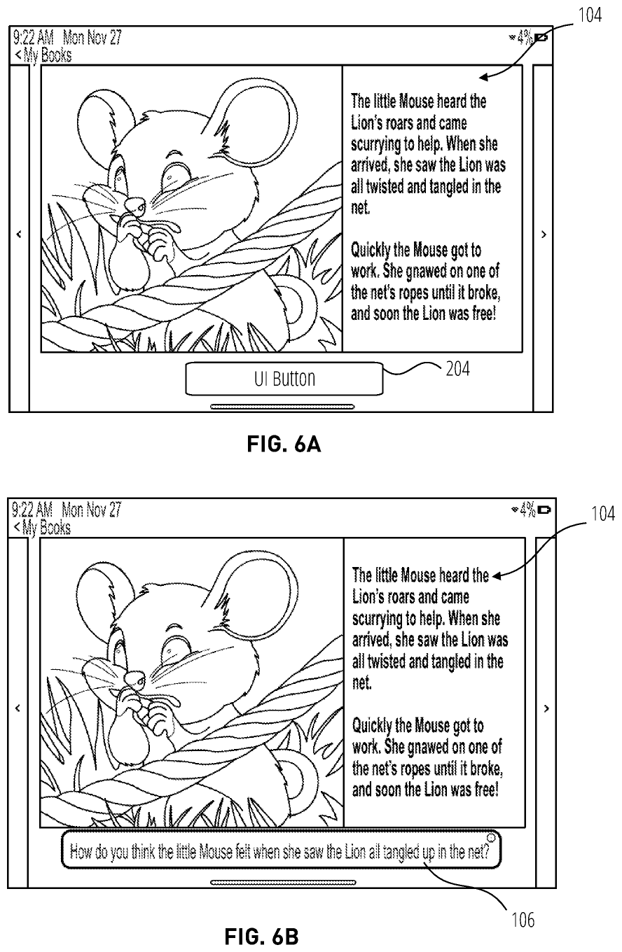

FIG. 6A illustrates an example of the book application at the time t=0 in accordance with some aspects of the present technology. The book application 102 includes story content 104 including an image and text associated with a children's book. Additionally, the book application 102 can present a UI button 204 that can receive a selection from a user requesting to generate a question that can promote dialogic reading.

FIG. 6B illustrates a sample of the book application at time t=1, which occurs after a suitable response has been provided by the generative model in accordance with some aspects of the present technology. The book application 102 again displays the story content 104 but has replaced the UI button 204 with a question that promotes dialogic reading 106 that has been generated by the generative model 104 and has been deemed suitable by the question-generating application 202.

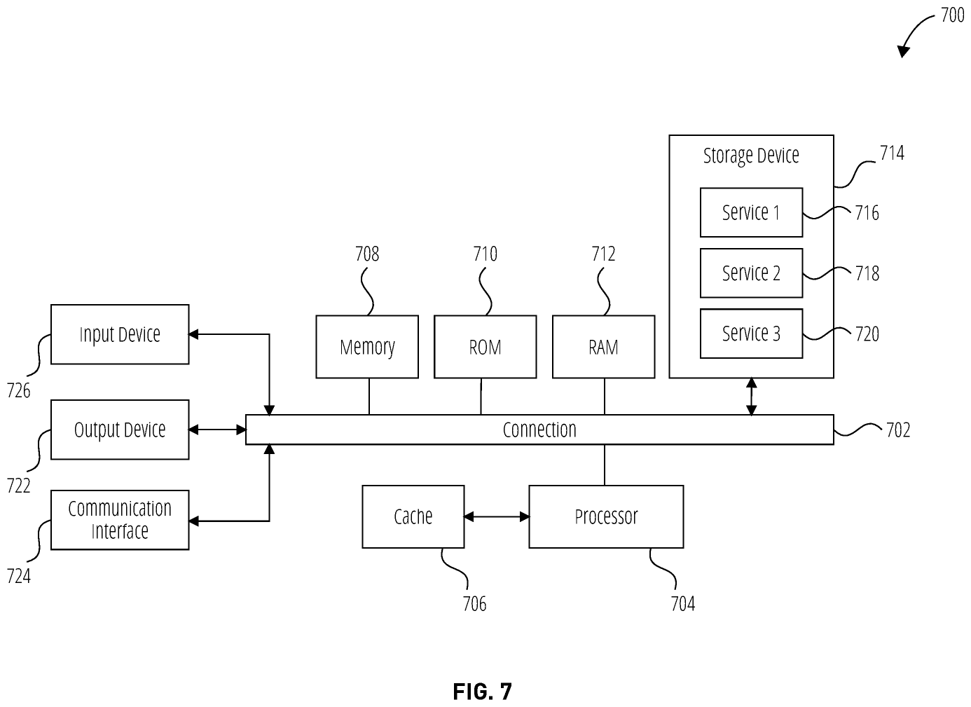

FIG. 7 shows an example of computing system 700, which can be for example any computing device making up the book application 102, question-generating application 202, or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 704 and connection 702 that couples various system components including system memory 708, such as read-only memory (ROM) 710 and random access memory (RAM) 712 to processor 704. Computing system 700 can include a cache of high-speed memory 706 connected directly with, in close proximity to, or integrated as part of processor 704.

Processor 704 can include any general purpose processor and a hardware service or software service, such as services 716, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### ASPECTS

The present technology includes computer-readable storage mediums for storing instructions, and systems for executing any one of the methods embodied in the instructions addressed in the aspects of the present technology presented below:

Aspect 1: A method of interacting with a large language model to get responses with improved quality without fine-tuning the large language model for the use case, the method comprising: generating, by a prompt generation service, a generation prompt from a combination of a first template and a portion of a content, wherein the content is a story, wherein the first template is one of several templates where the templates are engineered to cause a generative model to output a type of question that will facilitate a discussion of the content, wherein the generative model model is a large language model; providing, by the prompt generation service, the generated prompt to a generative model; receiving, by a response suitability service, a candidate response from the generative model, where the candidate response was created by the generative model in response to the generated prompt; providing a first suitability prompt to the generative model to evaluate the output based on a quality criteria, wherein the first suitability prompt is one of a plurality of suitability prompts provided to the generative model to evaluate characteristics of the candidate response, wherein the plurality of suitability prompts correspond to factors in a quality response rubric, where in the quality generation matrix addresses factors used to evaluate whether a question based on the story will facilitate the discussion of the content; receiving, by the response suitability service, a suitability response from the generative model, wherein the suitability response addresses whether the candidate response meets the quality criteria; and evaluating, by the response suitability service, the suitability response to determine whether the candidate response is suitable.

Aspect 2: The method of aspect 1, the method comprising: when the evaluating the suitability response results in a determination that the candidate response is not suitable when evaluating the candidate response in light of the first suitability prompt, wherein it is determined that the candidate response is not suitable when the suitability prompt includes a reason why the candidate response is not suitable in light of the quality criteria included in the first suitability prompt, generating by the prompt generation service, a revision prompt from a combination of the generation prompt, the candidate response, and the suitability response, wherein the revision prompt requests a revised response that addresses the reason why the candidate response is not suitable in light of the quality criteria included in the first suitability prompt.

Aspect 3: The method of any one of aspects 1-2, the method comprising: when the evaluating the suitability response results in a determination that the candidate response is suitable when evaluating the candidate response in light of the first suitability prompt, providing a second suitability prompt to the generative model to evaluate the output based on a second quality criteria.

Aspect 4: The method of any one of aspects 1-3, The method of claim 1, the method comprising: when the evaluating the suitability response results in a determination that the candidate response is suitable when evaluating the candidate response in light of the first suitability prompt, presenting the candidate response in a user interface.

Aspect 5: The method of any one of aspects 1-4, wherein the revision prompt is generated from a combination of the generation prompt, the candidate response, and the suitability response.

Aspect 6: The method of any one of aspects 1-5, wherein the plurality of suitability prompts correspond to quality criteria in a quality response rubric.

Aspect 7: The method of any one of aspects 1-6, wherein the quality criteria in the quality response rubric includes expert knowledge.

What is claimed is:

1. A method comprising:
receiving, by a response suitability service, a candidate response from a generative model;
providing a first suitability prompt to the generative model to evaluate an output based on a quality criteria;
receiving, by the response suitability service, a suitability response from the generative model, wherein the suitability response addresses whether the candidate response meets the quality criteria; and
evaluating, by the response suitability service, the suitability response to determine whether the candidate response is suitable.

2. The method of claim 1, further comprising:
generating a generation prompt from a combination of a first template and a portion of a content;
providing the generation prompt to the generative model, whereby the candidate response is created by the generative model in response to the generation prompt.

3. The method of claim 1, the method comprising:
when the evaluating the suitability response results in a determination that the candidate response is not suitable, wherein it is determined that the candidate response is not suitable when the suitability prompt includes a reason why the candidate response is not suitable in light of the quality criteria included in the first suitability prompt,
generating a revision prompt, wherein the revision prompt requests a revised response that addresses the reason why the candidate response is not suitable in light of the quality criteria included in the first suitability prompt.

4. The method of claim 3, wherein the revision prompt is generated from a combination of the generation prompt, the candidate response, and the suitability response.

5. The method of claim 1, the method comprising:
when the evaluating the suitability response results in a determination that the candidate response is suitable when evaluating the candidate response in light of the first suitability prompt,
providing a second suitability prompt to the generative model to evaluate the output based on a second quality criteria.

6. The method of claim 1, wherein the evaluating the suitability response results in a determination that the candidate response is suitable, the method comprising:
presenting the candidate response in a user interface.

7. The method of claim 1, wherein the first suitability prompt is one of a plurality of suitability prompts provided to the generative model to evaluate characteristics of the candidate response.

8. The method of claim 7, wherein the plurality of suitability prompts correspond to quality criteria in a quality response rubric.

9. The method of claim 8, wherein the quality criteria in the quality response rubric includes expert knowledge.

10. The method of claim 2, wherein the first template is one of several templates where the templates are engineered to cause a generative model to output a type of question that will facilitate a discussion of the content.

11. A computing system comprising:
a at least one processor; and
a memory storing instructions that, when executed by the at least one processor, configure the system to:
receive, by a response suitability service, a candidate response from a generative model;
provide a first suitability prompt to the generative model to evaluate an output based on a quality criteria;
receive, by the response suitability service, a suitability response from the generative model, wherein the suitability response addresses whether the candidate response meets the quality criteria; and
evaluate, by the response suitability service, the suitability response to determine whether the candidate response is suitable.

12. The computing system of claim 11, wherein the instructions further configure the system to:
generate a generation prompt from a combination of a first template and a portion of a content;
provide the generation prompt to a generative model, whereby the candidate response is created by the generative model in response to the generation prompt.

13. The computing system of claim 11, the instructions comprising:
when the evaluating the suitability response results in a determination that the candidate response is not suitable, wherein it is determined that the candidate response is not suitable when the suitability prompt includes a reason why the candidate response is not suitable in light of the quality criteria included in the first suitability prompt,
generate a revision prompt, wherein the revision prompt requests a revised response that addresses the reason why the candidate response is not suitable in light of the quality criteria included in the first suitability prompt.

14. The computing system of claim 13, wherein the revision prompt is generated from a combination of the generation prompt, the candidate response, and the suitability response.

15. The computing system of claim 11, the instructions comprising:
when the evaluate the suitability response results in a determination that the candidate response is suitable when evaluating the candidate response in light of the first suitability prompt,
provide a second suitability prompt to the generative model to evaluate the output based on a second quality criteria.

16. A non-transitory computer-readable storage medium comprising instructions that when executed by at least one processor, cause the at least one processor to:
receive, by a response suitability service, a candidate response from a generative model;
provide a first suitability prompt to the generative model to evaluate an output based on a quality criteria;
receive, by the response suitability service, a suitability response from the generative model, wherein the suitability response addresses whether the candidate response meets the quality criteria; and
evaluate, by the response suitability service, the suitability response to determine whether the candidate response is suitable.

17. The computer-readable storage medium of claim 16, wherein the instructions further configure the at least one processor to:
generate a generation prompt from a combination of a first template and a portion of a content;
provide the generation prompt to a generative model, whereby the candidate response is created by the generative model in response to the generation prompt.

18. The computer-readable storage medium of claim 16, the instructions comprising:
when the evaluating the suitability response results in a determination that the candidate response is not suitable,
generate a revision prompt, wherein the revision prompt requests a revised response that addresses the reason why the candidate response is not suitable in light of the quality criteria included in the first suitability prompt.

19. The computer-readable storage medium of claim 16, the instructions comprising:
when the evaluating the suitability response results in a determination that the candidate response is suitable when evaluating the candidate response in light of the first suitability prompt,
provide a second suitability prompt to the generative model to evaluate the output based on a second quality criteria.

20. The computer-readable storage medium of claim 17, wherein the first template is one of several templates where the templates are engineered to cause a generative model to output a type of question that will facilitate a discussion of the content.
